(19) United States
(12) Patent Application Publication
(10) Pub. No.: US 2011/0211768 A1
(43) Pub. Date: Sep. 1, 2011

(54) Method for Improving the Contrast of Images, Particularly Gray Tone Images, and Device for Carrying out Said Method

(76) Inventor: Michael Thoms, Bietigheim-Bissingen (DE)

(21) Appl. No.: 13/002,383

(22) PCT Filed: Jun. 23, 2009
(86) PCT No.: PCT/EP2009/004500

§ 371 Date: May 9, 2011

(30) Foreign Application Priority Data
Jul. 6, 2008 (DE) 10 2008 032 686.0

(51) Int. Cl. G06K 9/40

(52) U.S. Cl. 382/274

(57) ABSTRACT

A characteristic line is used for converting an initial image into a modified image that is composed of two characteristic lines that have different contrast enhancement properties.

### RELATED APPLICATIONS

This application claims the filing benefit International Patent Application Number PCT/EP2009/004500 filed on Jun. 23, 2009, which claims priority to German Patent Application Number 10 2008 032 686.0, filed on Jul. 6, 2008, the contents of both of which are incorporated herein by reference.

### TECHNICAL FIELD

The invention concerns a method for improving the contrast of images, particularly grey tone images, according to the pre-characterizing clause of Claim 1, and a device for carrying it out, according to the pre-characterizing clause of Claim 13.

### BACKGROUND OF THE INVENTION

Various measuring methods supply grey tone images as results. This includes the images which are obtained by irradiating workpieces and patients with X-rays. With other measuring methods, colour images are obtained.

It is known that the detectability of structures in grey tone images can be improved by emphasising differences of brightness more strongly. This emphasis takes place in practice, for example, using characteristic lines, which assign to a given grey tone of an initial image a different grey tone of a modified image. Characteristic lines which can be represented analytically are often used, in particular linear, polynomial (including fractional exponents) or logarithmic characteristic lines.

In general, it is true that the steeper the characteristic line which is used in the relevant grey tone range is, the more strongly the contrast is improved. With the contrast, the detectability of objects in the grey tone range under consideration also increases.

The known characteristic lines can improve the contrast either in the range of low grey tones or in the range of higher grey tones. In the other range, i.e. that of higher grey tones or low grey tones respectively, structure recognition becomes more difficult.

In the case of colour images, instead of a single pixel parameter (grey tone), there are multiple pixel parameters, which are necessary for complete description of a pixel: the colour, the colour saturation and the intensity. With each of these parameters, or a plurality of these parameters, it is possible to begin to sharpen the contrast of a colour image.

The present invention is directed to resolving these and other matters.

### SUMMARY OF THE INVENTION

This invention is intended to give a method for improving the contrast of images, said method resulting in a contrast improvement in different ranges of a pixel parameter simultaneously.

According to the invention, this object may be achieved by a method for improving the contrast of images, particularly grey tone images, particularly X-ray images, wherein pixel parameters of an initial image are converted into pixel parameters of a modified image using a characteristic line, characterized in that the pixel parameters of the initial image are converted in the pixel parameters of a further, modified image using at least one further characteristic line, and the modified images are superimposed into a total image, or the characteristic line is combined into a hybrid characteristic line using at least one further characteristic line, and the pixel parameters of the initial image are converted into a modified total image using the hybrid characteristic line.

In the method according to the invention, two modified images are calculated from an initial image using two different characteristic lines, each of which can achieve a good contrast improvement for a characteristic line range. These modified images are then superimposed, and a modified total image, with which contrast improvement is obtained in the corresponding characteristic line ranges, is obtained.

Alternatively, two different characteristic lines, which work differently with respect to contrast improvement, in particular can complement each other, can be combined into one hybrid characteristic line, and with it an initial image can be converted into a modified image which is richer in contrast.

For many cases, it is sufficient to use two different characteristic lines, of which one characteristic line has steep sections in the range of smaller grey tones, and the other characteristic line has a greater gradient in the range of greater parameters, to calculate two modified images.

Via the choice of characteristic line, not only the extent of contrast improvement in the individual characteristic line ranges can specify, but also the extent of the characteristic line ranges over which contrast improvement takes place.

Advantageous further developments of the invention are the subject of subclaims.

With the further development of the invention, the contrast improvement for the different characteristic line ranges can be taken into the modified total image to different extents.

In the case of a method,of the invention, the weighting which in total results in the best contrast improvement can easily be determined, which for example is possible by visual observation of the modified total image. However, the weighting can also be adjusted automatically using a program which evaluates and optimises the quality of the contrast automatically. For example, such programs can search in an image for lines, and take the total length of the detected lines as the figure of merit for the quality of the set weighting in each case, and vary the weighting automatically so that this figure of merit reaches its maximum.

Use of a characteristic line improves the detectability of structures in image areas with high parameters.

Another use of a characteristic line improves the detectability of structures in the case of small parameters.

The further development of the invention makes it possible to convert an initial image easily into a modified image.

The further development of the inventionis advantageous with respect to selecting the characteristic line according to properties of the current initial image.

With another method of the invention, a contrast improvement in those image areas of which the parameters are found frequently in the initial image can be obtained.

In contrast, those image areas of which the parameters are found rarely in the initial image can be represented with improved structure resolution.

In the case of another method of the invention, the effect, on the characteristic line specification, of those pixels which occur with very great frequency in the initial image is restricted. This restriction can be made analogously for pixels which are found specially rarely in the image.

By limiting the amplitude of the characteristic line smoothly, artefacts which are otherwise given at the adjacency points between the amplitude-limited range of the characteristic line and the adjacent ranges of the characteristic line are avoided.

A device of the invention makes it possible, with simple hardware means and clear programs, to improve the contrast of an initial image in different characteristic line ranges.

In the case of yet another device of the invention, a user can easily set the optimal contrast improvement for an initial image by a trial. As explained above, the optimal contrast improvement can also be carried out using a computing circuit or a routine, which calculates a contrast figure of merit from the total length of the detected lines.

The further development of the invention makes it possible, using simple means, to obtain a contrast improvement in different characteristic line ranges.

According to another development of the invention, it is specially easy for a user to set the optimal contrast improvement in the image areas which interest the user. It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 shows a block diagram of an X-ray or video recorder, with improvement of the contrast of a grey tone initial image;

FIG. 2 shows a block diagram of an X-ray recorder, with modified improvement of the contrast of a grey tone initial image;

FIG. 3 shows a schematic lateral arrangement of a sample for determining the quality of error detection in an X-ray recorder;

FIG. 4 shows a plan view of a test piece of the sample according to FIG. 4;

FIG. 5 shows a photograph of a grey tone initial image, which represents an X-ray image, which is by irradiating a sample according to FIG. 3;

FIG. 6 shows a representation of the frequency distribution of the grey tones in the grey tone initial image of the sample according to FIG. 3;

FIG. 7 shows a schematic representation of a combined characteristic line HK, which is obtained by combining a linearly growing characteristic line K1 and a frequency-based characteristic line K2, which is derived from the histogram according to FIG. 3;

FIG. 8 shows a comparison between the grey tone initial image of FIG. 2 and a modified image, which was obtained using the hybrid characteristic line according to FIG. 7;

FIG. 9 shows a similar representation to FIG. 6, but in which the histogram was amplitude-limited upward;

FIG. 10 shows a similar view to FIG. 7, but in which the amplitude-limited histogram according to FIG. 9 was used;

FIG. 11 shows a comparison between the initial image and a modified image, which was obtained using the hybrid characteristic line according to FIG. 10;

FIG. 12 shows a similar view to FIG. 11, but in which the amplitude was limited depending on noise;

FIG. 13 shows a characteristic line which is similar to those of FIGS. 7 and 10, but which was obtained using the histogram according to FIG. 12; and

FIG. 14 shows a comparison between the initial image and a modified total image, which was obtained using the characteristic line according to FIG. 13.

### DETAILED DESCRITPION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

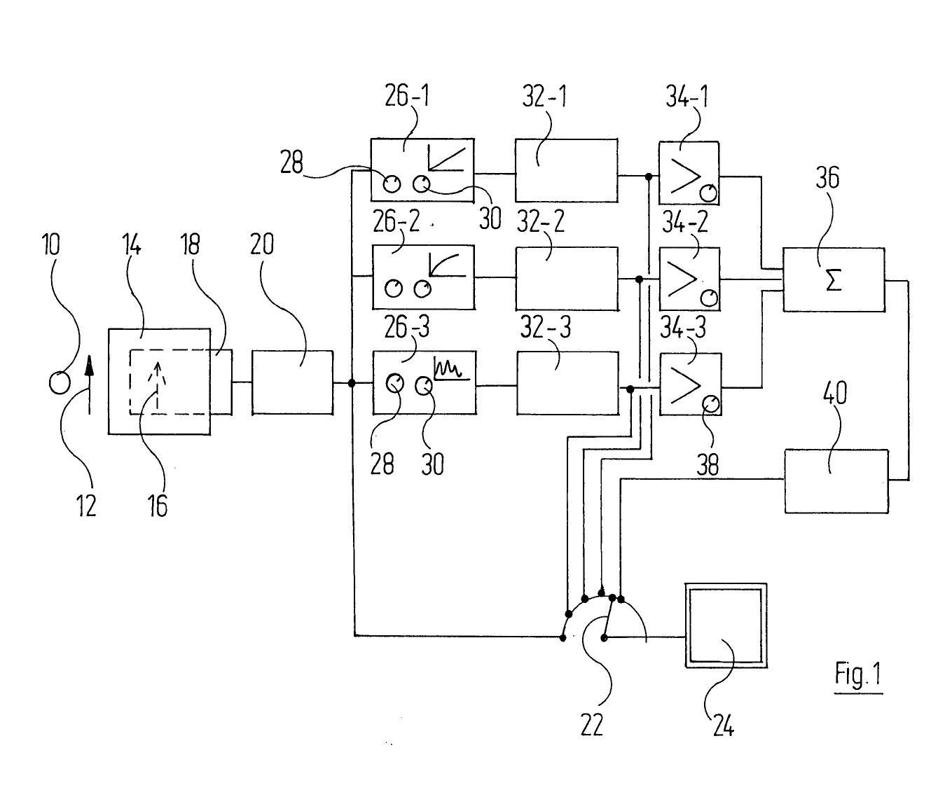

FIG. 1 shows an X-ray source 10, which throws a shadow of an object 12 onto an X-ray-sensitive image converter 14, which for example can be a CCD converter which is coated with an X-ray sintillation layer.

Alternatively, as the image carrier an image plate on which a latent image which is generated in the form of metastable excited colour centres, and which can be read out by a suitable scanner, comes into consideration.

The image 16, indicated by a dashed line, of the object 12 is read out via an operating circuit 18 of the image converter 14 or the image plate scanner, and provided as a grey tone initial image.

The latter is put onto an image memory 20, which thus contains the unprocessed initial image. The image memory 20 can be connected via a changeover switch 22 to a monitor 24, on which a user can assess the irradiation image of the object 12.

The output of the image memory 18 is also connected to a first characteristic line circuit 26-1, which for example, as shown schematically, works according to a linearly rising characteristic line. The characteristic line circuit 26 multiplies the grey tone value of each pixel of the initial image by a correction factor which increases linearly with the magnitude of the grey tone value.

On the characteristic line circuit 26-1, two adjustment buttons 28, 30, which are used to change the parameters of the characteristic line, are shown. These are the slope of the characteristic line and its zero offset.

The modified image which is converted by the characteristic line circuit 26-1 is stored in a further image memory 32-1.

The content of the image memory 32-1 is put via a multiplier 34-1 onto a first input of a superimposition circuit 36.

The multiplier 34-1 has an adjustment button 38, on which the multiplication factor can be set. The adjustable multiplier 34-1 thus corresponds to an amplifier of which the amplification factor can be adjusted.

The output signal of the image memory 20 is also put onto a characteristic line circuit 26-2, which works according to a root-shaped characteristic line, but otherwise is comparable to the characteristic line circuit 26-1. The modified image which the characteristic line circuit 26-2 calculates comes into an image memory 32-2, and is put via a further adjustable multiplier 34-2 onto the second input of the superimposition circuit 36.

The output signal of the image memory 20 also comes to a third characteristic line circuit 26-3, which works according to a characteristic line which is based on a grey tone frequency histogram. It thus improves the contrast in the case of the frequently occurring grey tones. The modified image which it generates is held in an image memory 32-3, and is weighted by a further adjustable multiplier 34-3 and put onto a third input of the superimposition circuit 36.

If desired, the series of characteristic line circuits 26 can be extended by further characteristic line circuit, the characteristic lines of which are specified on the basis of other magnitudes. Thus a further characteristic line circuit, which emphasises very noisy image areas less than image areas with a good signal-to-noise ratio, could be provided.

Thus at the output of the superimposition circuit 36, a weighted total image, which in the case of the embodiment under consideration consists of three modified images, is obtained.

The total image can also be subjected to a further contrast improvement, which is carried out in the spatial frequency space or longitudinal space. This includes Fourier transformation of the input image and emphasis of high frequency components of the Fourrier image. After reverse transformation into the spatial space, a contrast-improved image is again obtained, this contrast improvement being based on considerations concerning the size of structures to be detected.

A corresponding Fourier contrast improvement circuit is shown in the drawing at 40.

In the case of the embodiment according to FIG. 1 described above, the initial image was converted, using the different characteristic lines, into different modified images, which were then weighted and combined.

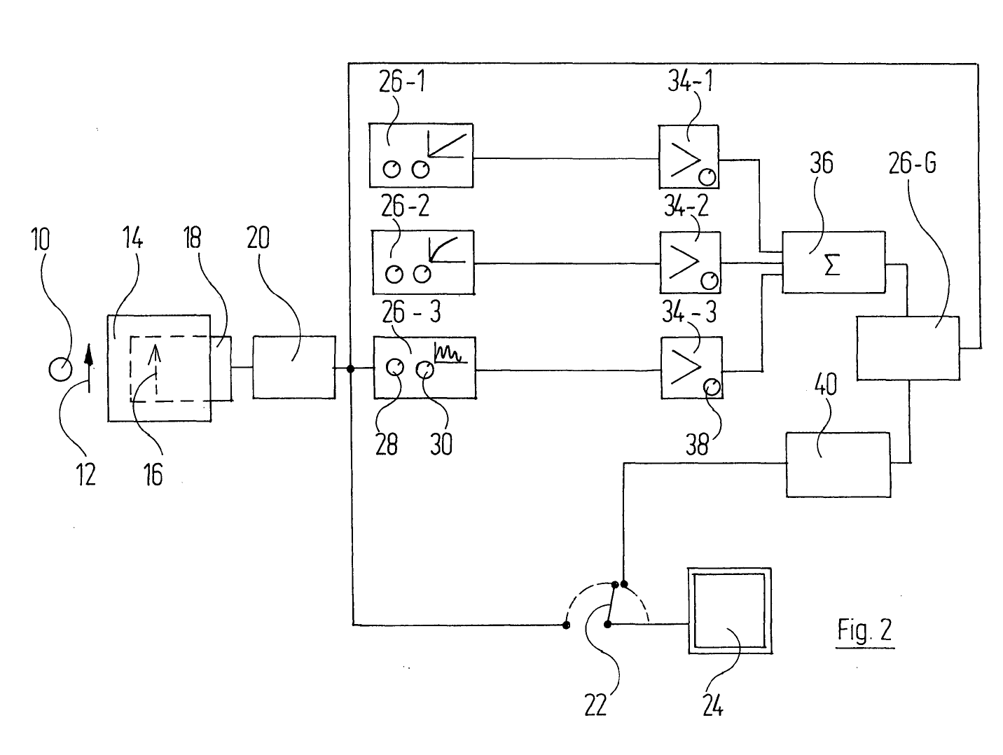

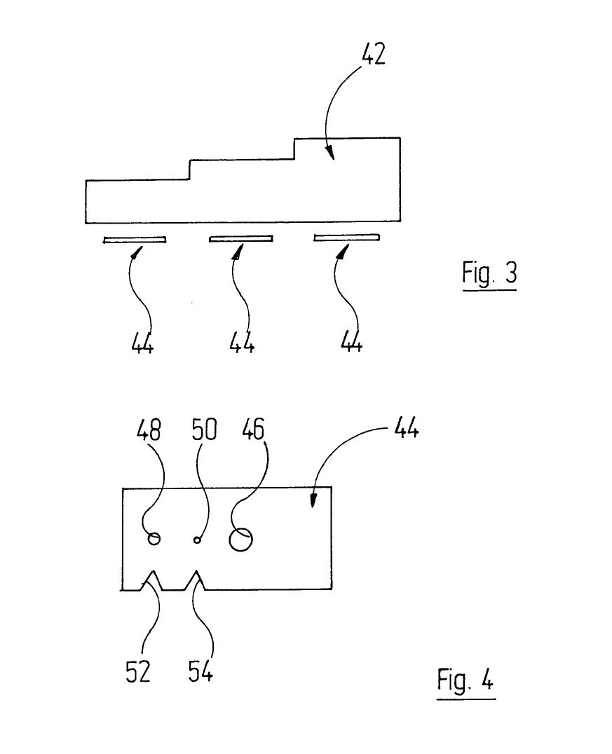

Alternatively, it is also possible to combine the characteristic line weights according to FIG. 2, and using the hybrid characteristic line, to calculate only a single modified image. Less memory and fewer computing operations are then required.

On the other hand, the circuit according to FIG. 1 has the advantage that the modified sub-images can also be viewed individually, and thus the effect of the different correction options can be better assessed individually. This can make the total optimisation of the contrast improvement easier.

In FIG. 2, elements which have already been explained with reference to FIG. 1 are again provided with the same reference symbols, even if they are different in detail. Below, only the differences are discussed.

The nature of the characteristic line circuits 26-1, 26-2 and 26-3 is that they each provide only one characteristic line, K1, K2 and K3 respectively. The image memories 32 are omitted, and the superimposition circuit 36 adds the weighted characteristic lines.

A further characteristic line circuit 26-G obtains from the superimposition circuit 36 a hybrid characteristic line HK which is obtained by weighted superimposition of the characteristic lines K1, K2 and K3 of the characteristic line circuits 26-1, 26-2 and 26-3, and modifies the initial image which is put onto it according to the hybrid characteristic line HK.

The nodified total image which is obtained in this way is again put onto the Fourier contrast sharpening circuit 40.

FIG. 3 shows a reducer body 42, which is made of aluminium and has three steps of different heights.

Under the steps of the reducer body 40, three test pieces 44, which consist of a thin sheet metal which is provided with three holes 46, 48, 50 of decreasing diameter, are arranged.

Two relatively large triangular marginal marks 52, 54 indicate the position of the smaller holes 48 and 50, which are harder to detect.

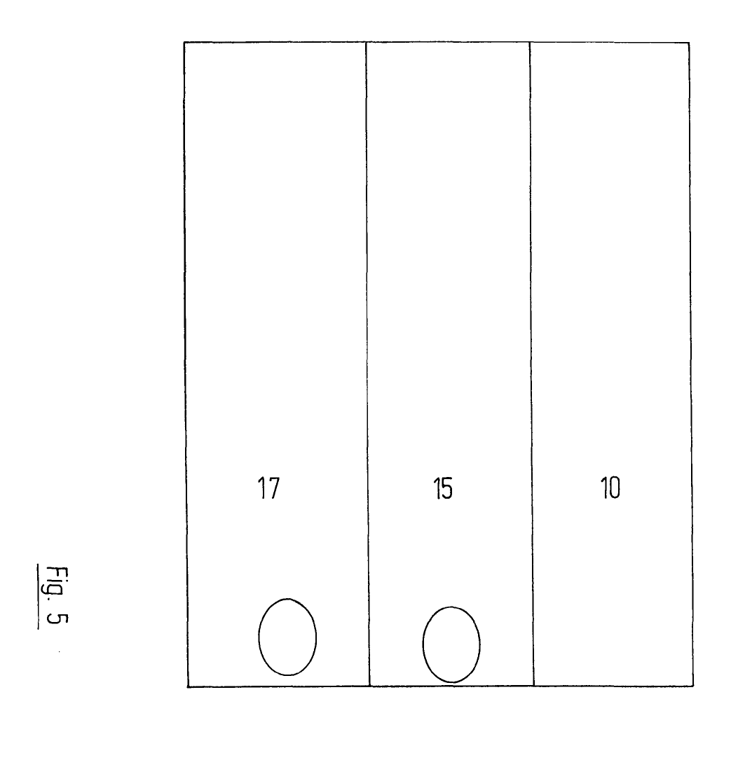

With reference to FIGS. 5ff, aspects of the selection of characteristic lines which are used in the characteristic line circuit 26 are now discussed.

FIG. 5 shows the initial image which is contained when the sample formed by the reducer body 42 and test piece 44 is irradiated. The steps of the reducer body are recognisable, but the test pieces 44 behind the reducer body 40 are practically invisible to the eye.

The initial image has a total of 1.5 million pixels.

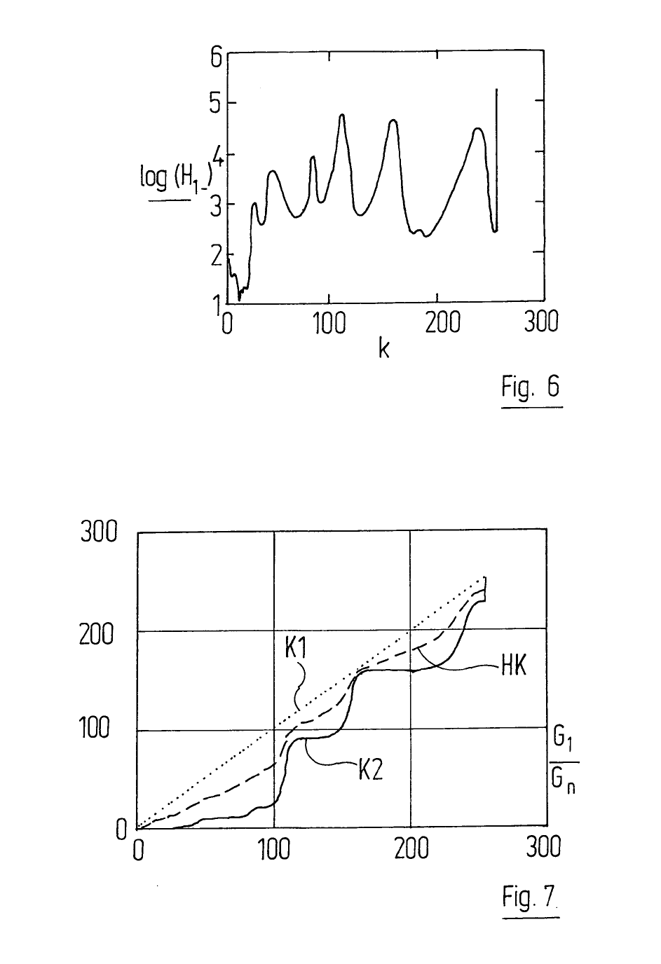

The histogram shown in FIG. 6 plots the frequency of the pixels over the grey tone at a logarithmic scale. The grey tone k is resolved with 8 bits, corresponding to 2⁸=256 shades of grey. As the measure of the grey tone, a number between 0 and 255 is then used.

It can be seen that the histogram has some distinct maxima, which should be assigned to steps of the reducer body 42 and the test pieces 44, which are invisible to the eye. This is because the image, according to the step structure of the reducer body, has three areas in which the grey tones of the pixels are approximately equal. By increasing the steepness of the characteristic line in these areas, the contrast is improved precisely there. This can be achieved by using the accumulated histogram directly as the characteristic line.

However, it is then found that in the areas of high frequency of the grey tones, over-emphasis takes place, so that the noise in the image area under consideration is raised too much, so that the visibility of the of the test pieces is not further improved.

In relation to this, it should be noted that detection of structures by eye must allow for the fact that the eye cannot detect structures below a threshold contrast.

Now, if a characteristic line which in part simply increases linearly with the grey tone value is taken, the disadvantage described above, of pure histogram adaptation, can be reduced. Such a linear characteristic line K1 is drawn as a dashed line in FIG. 7.

Now, if a new characteristic line which is obtained by weighted combination of the linear characteristic line K1 and a histogram characteristic line K2 is formed, a hybrid characteristic line HK, which is between the linear characteristic line K1 and the hybrid characteristic line K2, is obtained.

This mean characteristic line is drawn in FIG. 7 for equal amounts of linear characteristic line K1 and histogram characteristic line K2.

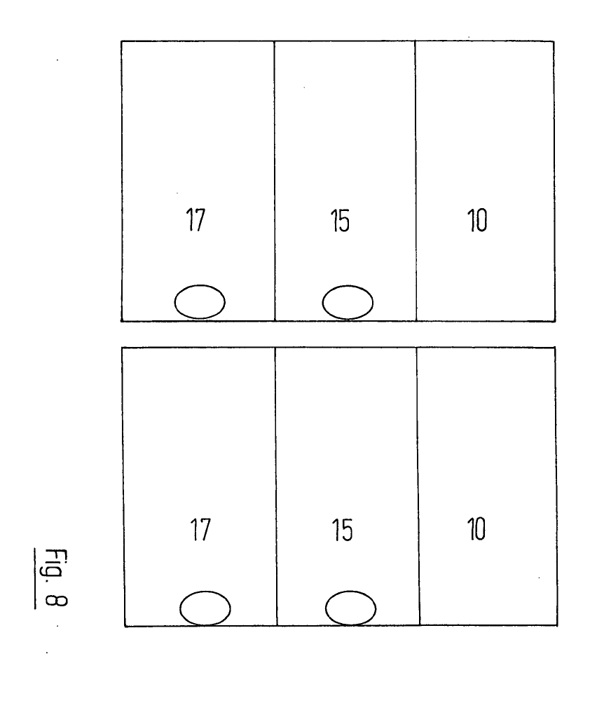

With this hybrid characteristic line HK, the results shown in FIG. 8 are then obtained. In the modified total image on the left in FIG. 8, the shadow of the rectangular test piece 44 and the largest of its holes are clearly detected. In the initial image shown on the right in FIG. 5, a shadow of the test body can be detected straight yet highest image strips, if it is deliberately searched for.

If the linear characteristic line is designated K1, and the histogram characteristic line is designated K2, for the total characteristic line or hybrid characteristic line HK the following applies:

HK=(1−a)×K1+a×K2

It can be seen that by varying the parameter a, the contributions of the characteristic lines K1 and K2 to the total characteristic line HK can be continuously changed.

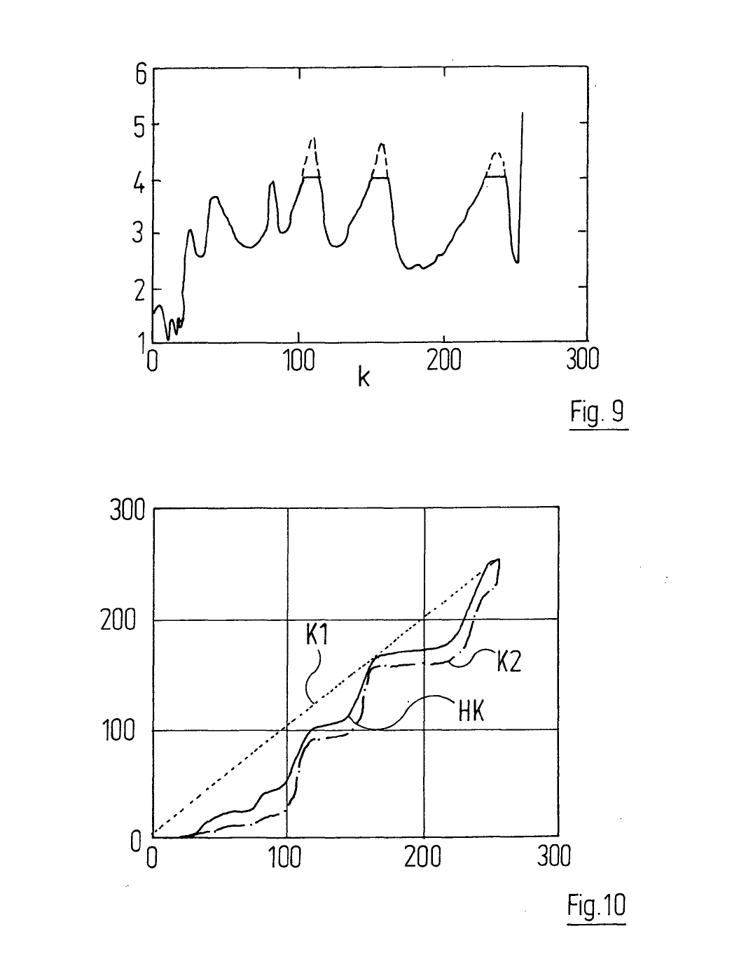

FIG. 9 shows the histogram of FIG. 6, in which however the frequency peaks above the ordinate “4” were capped.

FIG. 10 shows the total characteristic line HK, which is again obtained from K1 and K2, with a=0.5. It can be seen that the total characteristic line rises less steeply near the maxima of the frequency points.

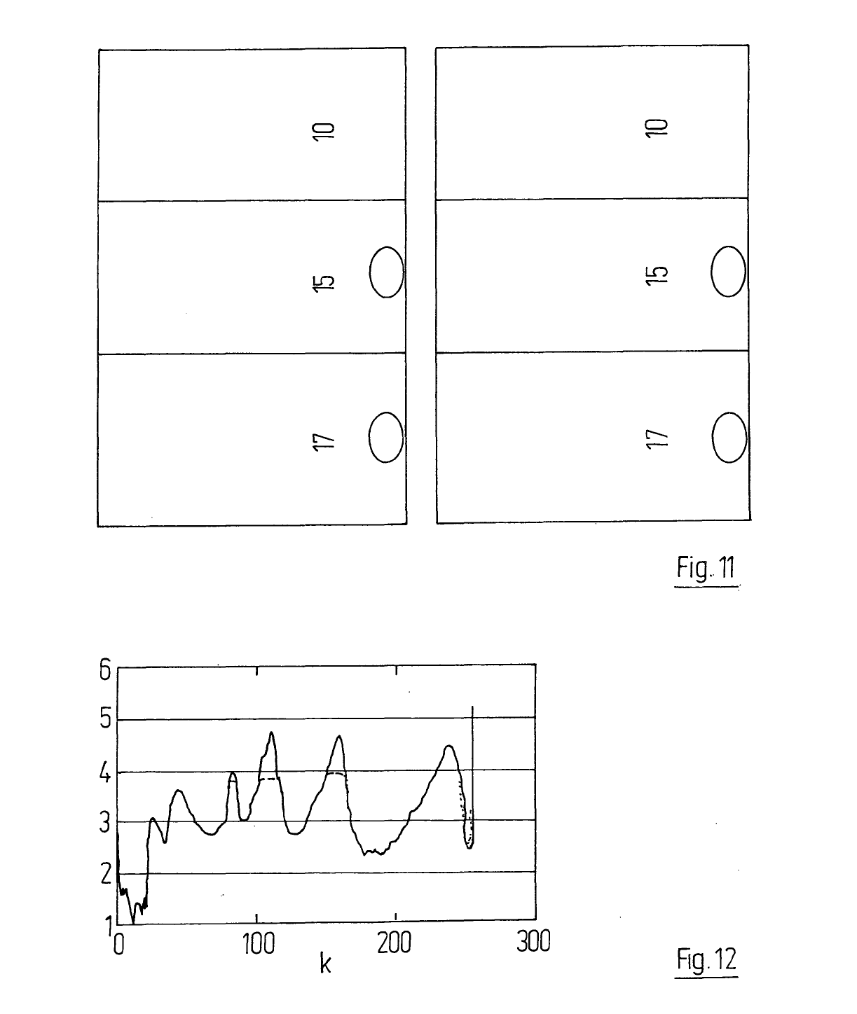

FIG. 11 shows the thus obtained modified total image (left) in comparison with the initial image (right). It can be seen that the modified sub-image is less noisy than in the modified sub-image shown in FIG. 8, but that the edges of the test piece and its structures are still easily visible.

According to FIG. 12, a k-dependent limitation of the frequency curve takes place. The amplitude is reduced according to the root of k, so that a slight rise of the frequency peak plateaus, which are obtained after the limitation, is obtained.

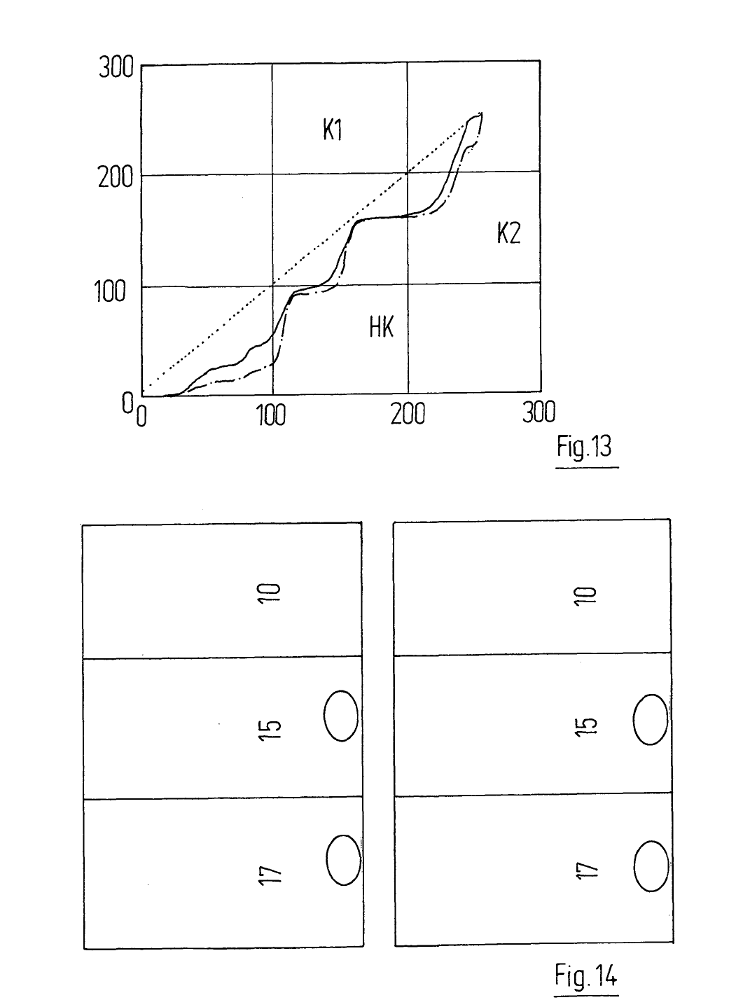

FIG. 13 shows a total characteristic line HK, which was obtained on the basis of the histogram characteristic line of FIG. 12, which was limited according to the root of the grey tone amplitudes.

In FIG. 14, the modified total image which was obtained with the total characteristic line HK of FIG. 13 is again contrasted with the initial image.

It can be seen that in this way too, a low-noise modified total image which for small and medium grey tone values also provides good results, and for high grey tone values is somewhat worse than for the characteristic line HK of FIG. 10, is obtained. However, with respect to noise the image can also be satisfactory.

It is understood that combination characteristic lines can also be produced in other ways, by using for the characteristic line K1 functions other than a linear straight line, e.g. a logarithmic function. In this way, the gradients in the ranges of the characteristic line K corresponding to high K values become more distinct again.

In the case of the embodiment according to FIG. 1 described above, the initial image was converted, using the different characteristic lines, into different modified images, which were then weighted and combined.

Alternatively, it is also possible to combine the characteristic line weights, and using the hybrid characteristic line, to calculate only a single modified image. Less memory and fewer computing operations are then required.

On the other hand, the circuit according to FIG. 1 has the advantage that the modified sub-images can also be viewed individually, and thus the effect of the different correction options can be better assessed individually. This can make the total optimisation of the contrast improvement easier.

Further modifications are possible as follows:

The method described above can also be applied to sliding image sections.

Instead of a fixed function for k-dependent capping of those peaks of the frequency function H(k) which are above a threshold value H_{S}, e.g. capping according to a root function, as explained in relation to FIG. 12, it is also possible to apply a function which grows more weakly than linearly to the whole histogram, e.g. to specify a modified histogram H*(k) as H*=SQRT(H(k)). This has the advantage that the modified histogram H*(k) has no edges, as would be the case with the step function.

In general, such a modified histogram has the form

H*(k)=f(H(k), k),

the mapping function preferably being a continuous and preferably less than linearly growing function.

However, for many purposes partially continuous modified histograms H*(k) can well be used, e.g.

H*(k)=H for H(k)<H_{S}(H_{S}=threshold value)

H*(k)=f(H(k), K) for H(k)≧H_{S}

For example, f(H(k), k) can be chosen to be a x (SQRT(H(k)), as considered above, where a is a parameter which ensures the absence of a step in the modified histogram at H_{S}: a=SQRT(H_{S}).

The contrast sharpening was described above on the basis of grey tone images. The method described above can equally be used with colour images. These differ from the grey tone images, in which a pixel have only one pixel parameter (the grey tone value), in that a pixel has multiple pixel parameters, that is the colour, the colour saturation and the brightness.

For each of these pixel parameters, histograms can be produced as was presented above for the grey tone in isolation. Then, on the basis of these histograms, the colour and/or colour saturation and/or brightness can be modified, as presented above for grey tones.

However, in the case of a colour image there are additional possibilities for better visualisation of contrasts, consisting not only of modifying the brightness on the basis of a histogram so that the contrast is improved, but also changing the colour and/or colour saturation in this way. The structures to be detected are then additionally brought out by a “false colour.”

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1.-16. (canceled)

17. A method for improving the contrast of images comprising the steps of:
converting pixel parameters of an initial image into pixel parameters of a first modified image using a first characteristic line;
converting the pixel parameters of the initial image into pixel parameters of a second modified image using at least a second characteristic line; and,
superimposing the first modified image and the second modified image into a total image.

18. The method of claim 17, wherein the first modified image and the second modified image have different weighting.

19. The method of claim 17 wherein at least one of the characteristic lines increases continuously with growing pixel parameters.

20. The method of claim 17, wherein at least one of the characteristic lines decreases at least in a range with growing pixel parameter.

21. The method of claim 17, wherein a gradient of at least one of the characteristic lines decreases towards high pixel parameters.

22. The method of claim 17, wherein a gradient of at least one of the characteristic lines increases at least in a range.

23. The method of claim 17, wherein at least one of the characteristic lines can be represented by a closed analytical expression.

24. The method of claim 17, wherein at least one of the characteristic lines reflects an accumulated frequency distribution of the pixel parameters of the initial image.

25. The method of claim 24, wherein a gradient of at least one of the characteristic lines reflects a frequency course and is proportional to the frequency distribution of the pixel parameters of the initial image.

26. The method of claim 24, wherein a gradient of at least one of the characteristic lines reflects a frequency of the pixel parameters of the initial image and behaves oppositely of the frequency distribution of the pixel parameters.

27. The method of claim 17, further comprising the step carrying out an amplitude limitation of at least one of the characteristic lines.

28. The method of claim 27, wherein the amplitude limitation is smooth resulting in the at least one characteristic line being continuous and smooth.

29. A device for improving the contrast of images comprising:
an image memory which contains pixel parameters of an initial image;
a characteristic line circuit which converts the pixel parameters of the initial image into a first modified image using a characteristic line;
a second characteristic line circuit which converts the pixel parameters of the initial image into a second modified image using a second characteristic line;
a superimposition circuit which combines the first modified image and the second modified image into a total image.

30. The device of claim 29, further comprising means for adjusting at least one parameter of at least one of the characteristic lines.

31. The device of claim 29 further comprising weighting means for the modified images.

32. A method for improving the contrast of images comprising the steps of:
combining at least a first characteristic line with at least a second characteristic line to form at least one hybrid characteristic line; and,
converting pixel parameters of an initial image into pixel parameters of a first modified image using the hybrid characteristic line.

33. The method of claim 32, wherein the characteristic lines have different weighting.

34. The method of claim 32, wherein the modified sub-image is combined into a modified total image with different weighting, and/or the characteristic lines are combined into the at least one hybrid characteristic line with different weighting.

35. The method of claim 32 wherein at least one of the characteristic lines increases continuously with growing pixel parameter.

36. The method of claim 32 wherein at least one of the characteristic lines decreases at least in a range with growing pixel parameter.

37. The method of claim 32 wherein the gradient of at least one of the characteristic lines decreases towards high pixel parameters.

38. The method of claim 32 wherein the gradient of at least one of the characteristic lines increases at least in a range.

39. The method of claim 32 wherein at least one of the characteristic lines can be represented by a closed analytical expression.

40. The method of claim 32 wherein at least one of the characteristic lines reflects the accumulated frequency distribution of the pixel parameters of the initial image.

41. The method of claim 40 wherein the characteristic line gradient, which reflects a frequency course, is proportional to the frequency of the pixel parameters.

42. The method of claim 40 wherein the characteristic line gradient, which reflects a frequency of the pixel parameters, behaves oppositely to the frequency distribution of the pixel parameters.

43. The method of claim 32 wherein an amplitude limitation of at least one of the characteristic lines downward or upward is carried out.

44. The method of claim 44 wherein the amplitude limitation takes place smoothly, so that an amplitude-limited characteristic line is continuous and smooth.

45. A device for improving the contrast of images comprising:
an image memory which contains pixel parameters of an initial image;
a characteristic line circuit having a first characteristic line;
a second characteristic line circuit having a second characteristic line;
further characteristic circuits each having further characteristic lines;
a superimposition circuit which superimposes the characteristic lines a into a hybrid characteristic line; and,
a hybrid characteristic line circuit which calculates a modified total image by using the hybrid characteristic line.

46. The device of claim 45, further comprising means for adjusting at least one parameter of at least one of the characteristic lines.

47. The device of claim 45 further comprising weighting means for the characteristic lines.
